(19) United States
(12) Patent Application Publication
(10) Pub. No.: US 2016/0067908 A1
(43) Pub. Date: Mar. 10, 2016

(54) BIOCHIP AND METHOD OF MAKING THE SAME

(71) Applicant: Taiwan Green Point Enterprises Co., Ltd., Taichung City (TW)

(72) Inventors: Sheng-Hung YI, Taichung City (TW); Pi-Ying LIU, Taichung City (TW); Sung-Yi YANG, Taichung City (TW); Yi-Cheng LIN, Taichung City (TW)

(73) Assignee: TAIWAN GREEN POINT ENTERPRISES CO., LTD., Taichung City (TW)

(21) Appl. No.: 14/844,369

(22) Filed: Sep. 3, 2015

(30) Foreign Application Priority Data
Sep. 4, 2014 (TW) 103130587

(51) Int. Cl. B29C 59/00; B01L 3/00; B29C 45/14

(52) U.S. Cl. CPC B29C 59/002; B29C 45/14; B01L 3/5085; B29K 2083/00

(57) ABSTRACT

A biochip includes a substrate and a patterned polymer layer molded over the substrate and formed with at least one recess that is adapted to receive biological analytes to be detected using a reader. The patterned polymer layer is bonded to the substrate through molding techniques and has structural characteristics indicative of the patterned polymer layer being formed by molding techniques. A method for making the biochip is also disclosed.

### CROSS-REFERENCE TO RELATED APPLICATION

This application claims priority of Taiwanese Patent Application No. 103130587, filed on Sep. 4, 2014.

### FIELD

Embodiments of the present disclosure generally relate to a biochip and a method of making the same, more particularly to a biochip including a polymer layer molded on a substrate and a method of making the same.

### BACKGROUND

Referring to FIG. 1, US Patent Application Publication NO. 2005/0106607 A1 discloses a method of making a biochip with a reaction well. The method includes: (a) providing a polymer film 11 which is made from polydimethylsiloxane (PDMS), polystyrene (PS), or polypropylene (PPR); (b) forming a plurality of openings 110 in the polymer film 11; (c) providing a substrate 12 which is made from quartz, glass, plastic, Si or polymer; (d) subjecting the substrate 12 to surface treatment; (e) attaching the polymer film 11 to the substrate 12 to form a plurality of reaction wells 13 that are respectively defined by the openings 110; and (f) disposing respectively a plurality of probes 14 in the reaction wells 13 so as to form the biochip.

The openings 110 in the polymer film 11 are formed using imprinting or casting techniques. The surface treatment of the substrate 12 in step (d) is conducted by coating thereon a material, such as poly(styrene-co-maleic-anhydride) (PSMA), Au, or Ni, so as to improve the adhesion of the probes 14 on the substrate 12. The probes 14 are made from deoxyribonucleic acids (DNA), proteins, or cells.

Since the polymer film 11 is thin and soft, removal of the same from a mold employed in the imprinting techniques and attachment of the same to the substrate 12 are required to be carried out manually, which is rather difficult and tedious and which tends to result in deformation and/or damage to the polymer film 11. If a thick polymer film is used, it is unfavorable to achieve the goal of miniaturization in the size of the biochip.

### SUMMARY

Certain embodiments of the disclosure provide methods of making a biochip that may alleviate at least one of the drawbacks, and/or biochips having a polymer layer.

In certain embodiments of the disclosure, a method of making a biochip may be provided. Such a method may include: providing a mold including first and second mold halves, the first mold half being formed with an accommodating groove, the second mold half being provided with a patterning member facing toward the accommodating groove; securing a substrate in the accommodating groove; disposing a polymer material on the substrate; patterning the polymer material through the patterning member in the mold; and curing the polymer material so as to form a patterned polymer layer on the substrate.

The patterned polymer layer may be formed with at least one recess having a pattern that corresponds to that of the patterning member and that is adapted to receive a biological analytes.

In certain embodiments of the disclosure, a biochip may be provided. Such a biochip may include a substrate and a patterned polymer layer molded over the substrate and formed with at least one recess that is adapted to receive a biological analytes.

The patterned polymer layer may be bonded to the substrate through molding techniques and have structural characteristics indicative of the patterned polymer layer being formed by molding techniques.

### BRIEF DESCRIPTION OF THE DRAWINGS

Other features and advantages of the disclosure will become apparent in the following detailed description of the exemplary embodiments with reference to the accompanying drawings, of which:

FIG. 1 is a perspective view of a biochip;

FIGS. 2A to 2C are sectional views of an embodiment illustrating consecutive steps of making a biochip according to the disclosure;

FIG. 3 is a sectional view illustrating covering a patterned polymer layer of an assembly with a sealing layer;

FIG. 4 is a sectional view illustrating ejecting the assembly of the patterned polymer layer and the substrate from a first mold half;

FIG. 5 is a perspective view of a biochip according to the disclosure; and

FIGS. 6A to 6C are sectional views of an embodiment illustrating consecutive steps of making the biochip according to the disclosure.

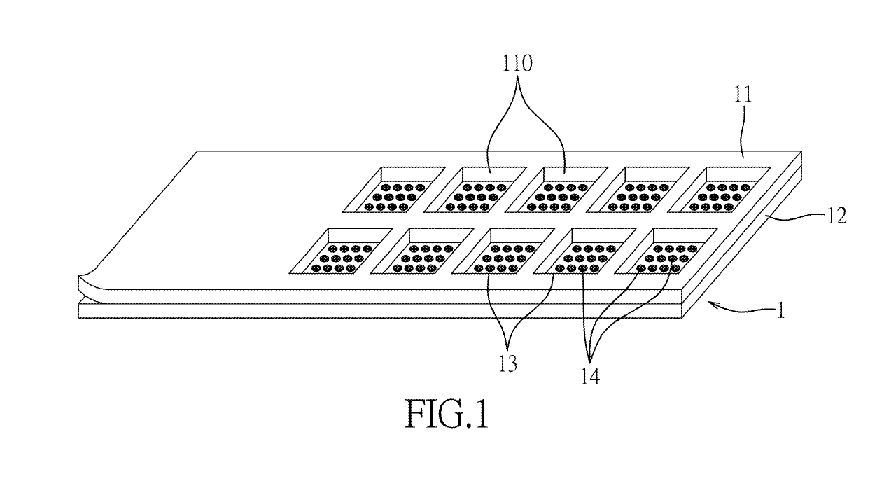

### DETAILED DESCRIPTION

It may be noted that like elements are denoted by the same reference numerals throughout the disclosure.

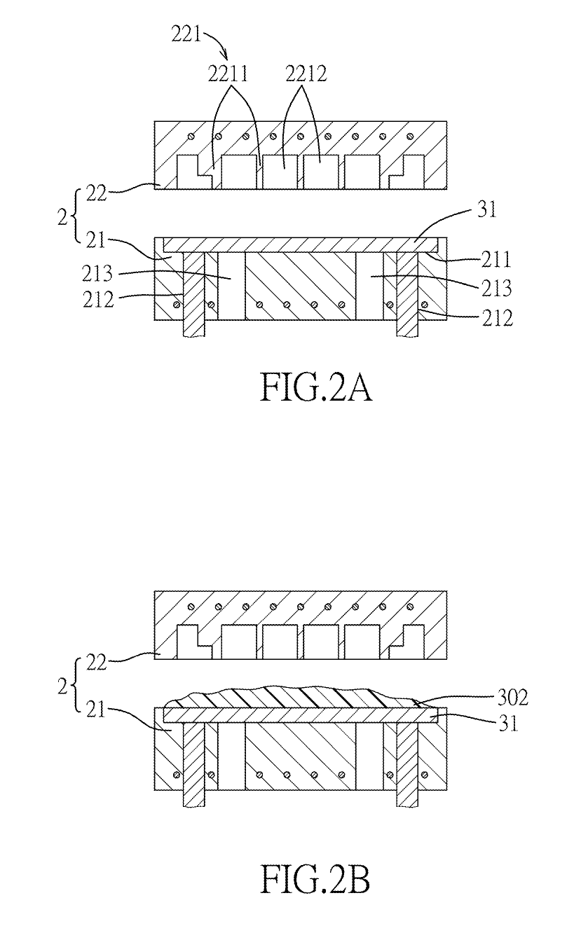

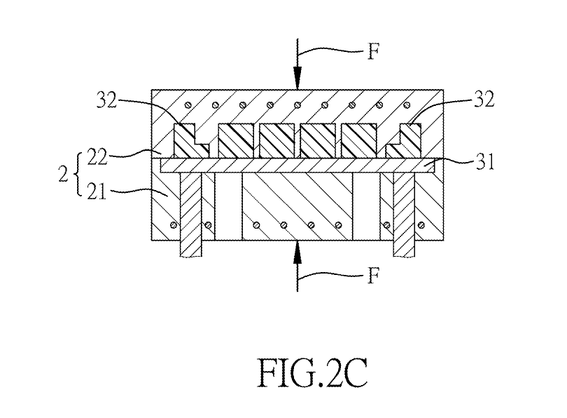

FIGS. 2A to 2C, FIG. 3 and FIG. 5 illustrate consecutive steps of a first embodiment of a method of making a biochip according to the disclosure. The method may include the following steps S1 to S9.

In step S1 (see FIG. 2A), a mold 2 including first and second mold halves 21, 22 is provided. The first mold half 21 is formed with an accommodating groove 211. The second mold half 22 is provided with a patterning member 221 facing toward the accommodating groove 211. The first mold half 21 is further formed with at least one suction channel 213 (e.g., two channels are shown in the figures) that is in fluid communication with the accommodating groove 211. The patterning member 221 has a plurality of protruding blocks 2211 which protrude from an inner surface of the second mold half 22 and which cooperatively define a pattern-forming recess 2212.

In step S2 (see FIG. 2A), a substrate 31 is secured in the accommodating groove 211.

In step S3 (see FIG. 2A), the accommodating groove 211 is suctioned through the suction channel 213 using a suction device (not shown), so that the substrate 31 is brought into abutment against the first mold half 21 by the suctioning action.

In step S4 (see FIG. 2B), a polymer material 302 is disposed on the substrate 31 in the mold 2.

In step S5 (see FIG. 2C), the first and second mold halves 21, 22 are assembled together after the disposing of the polymer material 302 on the substrate 31.

In step S6 (see FIG. 2C), the polymer material 302 is pressed by the mold 2 to fill the pattern-forming recess 2212 in the patterning member 221 so as to be patterned through the patterning member 221 in the mold 2.

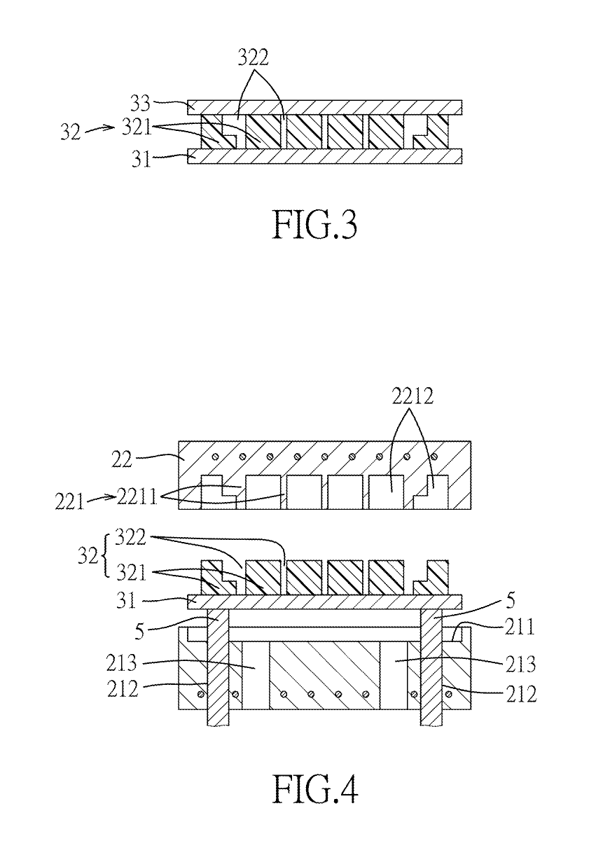

In step S7, the polymer material 302 is cured (or cross-linked) in the mold 2 so as to form a patterned polymer layer 32 on the substrate 31. The patterned polymer layer 32 thus formed has at least one recess 322 (see FIG. 3) with a pattern that are defined by the protruding blocks 2211 (i.e., that corresponds to that of the protruding blocks 2211 of the patterning member 221) and that is adapted to receive biological analytes to be detected using a reader (not shown). The at least one recess 322 in the patterned polymer layer 32 is defined by a plurality of generally rectangular protrusions 321 which protrude from the substrate 31 and which have a pattern corresponding to that of the pattern-forming recess 2212 in the patterning member 221. In certain embodiments, the patterned polymer layer 32 may have a grid-like structure (not shown) that defines an array of spaced-apart recesses 322, which serve as reaction wells for accommodating probes for detection of the biological analytes.

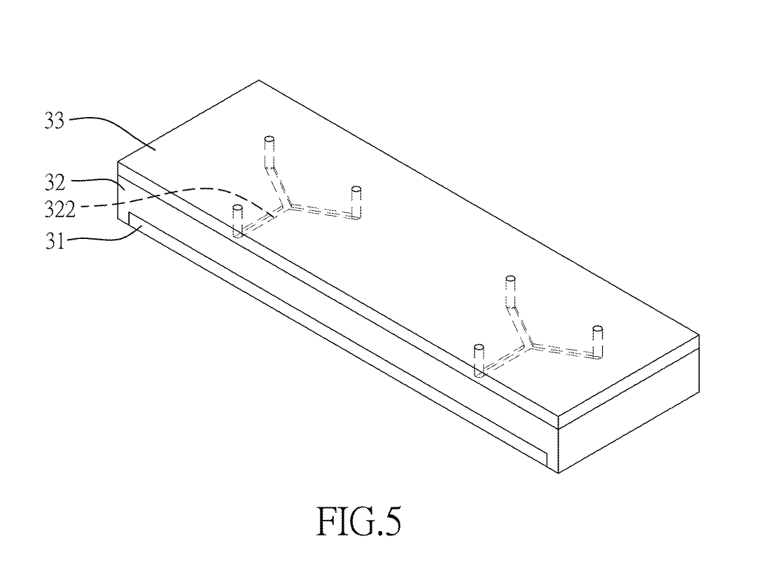

In step S8 (see FIG. 4), the first and second mold halves 21, 22 are disassembled and an assembly of the patterned polymer layer 32 and the substrate 31 is removed from the accommodating groove 211.

In step S9 (see FIG. 3), the patterned polymer layer 32 of the assembly is sealingly covered with a sealing layer 33 to seal the recess 322 in the patterned polymer layer 32.

Since the patterned polymer layer 32 is molded over the substrate 31 and is bonded to the substrate 31 through molding techniques, the patterned polymer layer 32 has structural characteristics indicative of the patterned polymer layer 32 being formed by molding techniques.

In certain embodiments, the substrate 31 may be made from metal, ceramics, glass, quartz, or polymer.

In certain embodiments, the polymer material 302 may be solid or in the form of a gel. In such embodiments, the polymer material 302 may be made from polysiloxane or silicone resins. The silicone resin may be a liquid silicone resin (LSR) or a solid silicone resin. In certain embodiments, the polymer material 302 may be self-adhesive solid silicone resin, so that a surface treatment, such as plasma treatment, to the substrate 31 may be omitted. In certain embodiments, the polymer material 302 may be an elastomer.

In certain embodiments, the polymer material 302 may be thermally curable or light curable. When the polymer material 302 is light curable, at least one of the first and the second mold halves 21, 22 may be transparent for passage of light therethrough into the mold 2 for curing the polymer material 302. When the first mold half 21 is transparent, the substrate 31 should also be transparent for passing light from the first mold half 21 to the polymer material 302.

The first mold half 21 may include an overflow-receiving groove (not shown) that surrounds and that is not in fluid communication with the accommodating groove 211, and that is adapted to receive an overflow of the polymer material 302 injected into the mold 2.

Referring to FIGS. 2(A) and 4, the first mold half 21 is further formed with at least one pin slot 212 (e.g., two slots are shown in the figures) that is in spatial communication with the accommodating groove 211, and the first mold half 21 may be provided with at least one ejecting pin 5 that extends into the pin slot 212. As such, the removal of the assembly of the substrate and the patterned polymer layer 32 from the accommodating groove 211 may be conducted by injecting a gas into the suction channel 213 and pushing the ejecting pin 5 into the accommodating groove 211 so as to eject the assembly of the substrate 31 and the patterned polymer layer 32 from the accommodating groove 211.

In certain embodiments, the polymer material 302 is a thermally curable material, and the method may further include a step of heating the mold 2 to a predetermined temperature to thermally cure the polymer material 302 in the mold 2. In certain embodiments, the predetermined temperature may range from 100° C. to 150° C.

It is noted that the predetermined temperature set for curing the polymer material 302 is sufficient to accelerate the curing of the polymer material 302, but should not cause undesired deformation of the substrate 31.

In certain embodiments, the method may further include a step of applying an external force (F) (see FIG. 2C) to the first and second mold halves 21, 22, so that the polymer material 302 is pressed by the mold 2 against the substrate 31 during patterning the polymer material 302 through the patterning member 221 in the mold 2. The external force(F) may be a biaxial force applied to the first and second mold halves 21, 22 or an uniaxial force applied to one of the first and second mold halves 21, 22 while the other one of the first and second mold halves 21, 22 maybe secured to a support base (not shown).

In certain embodiments, the polymer material 302 may be a self-adhesive solid silicone resin and the patterning and curing of the polymer material 302 in the mold 2 is carried out using hot press techniques.

In certain embodiments, the patterned polymer layer 32 may be covered with and bonded to the sealing layer 33 using a glue or an adhesive material which is applied to a surface of the patterned polymer layer 32 that is opposite to the substrate 31. Alternatively, the surface of the patterned polymer layer 32 maybe subjected to plasma treatment for bonding with the sealing layer 33.

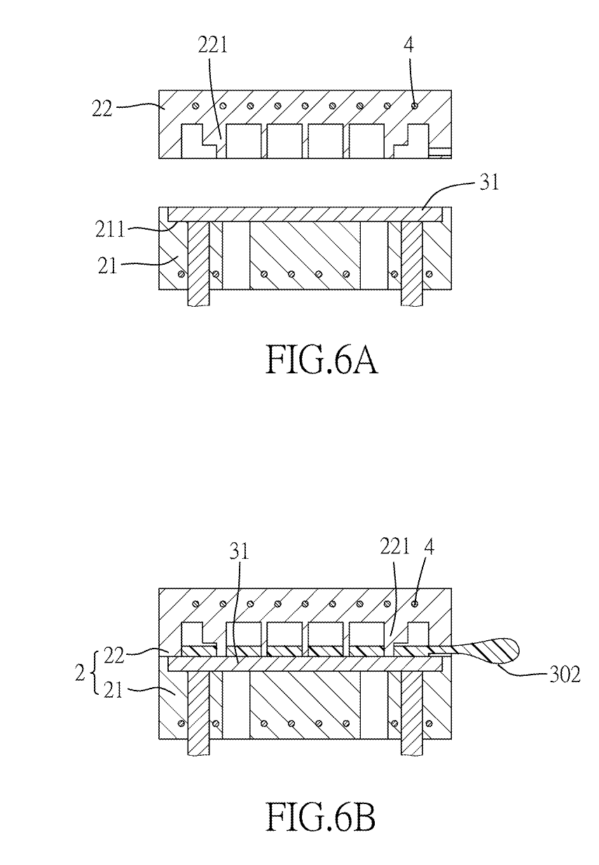

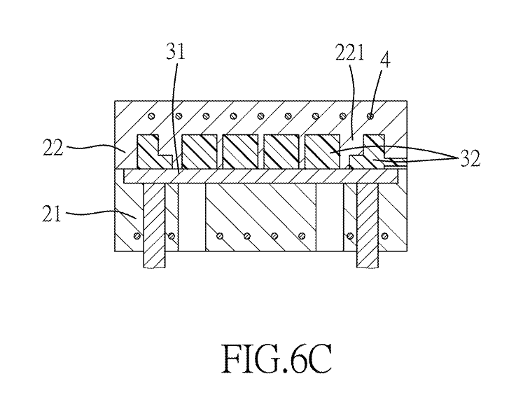

FIGS. 6A to 6C illustrate a second embodiment of the method of making the biochip according to the disclosure. The second embodiment differs from the first embodiment in that the patterning and curing of the polymer material 302 of the second embodiment is carried out using injection molding techniques.

In this embodiment, the first and the second mold halves 21, 22 are assembled together before the disposing of the polymer material 302 on the substrate through injection molding techniques. In certain embodiments, the second mold half 22 is heated to a predetermined temperature using a heater 4 before injection of the polymer material 302 into the mold 2 for subsequent patterning and curing (or cross-linking) of the polymer material 302.

The polymer material 302 maybe cooled after being injected into the mold 2 and subjected to crosslinking reaction. The assembly of the polymer material 302 and the substrate 32 is subsequently removed from the mold 2. The polymer material 302 employed in this embodiment may be self-adhesive liquid silicone resin which has a good flowability to flow through a runner system (not shown) in the mold 2 and to fill the pattern-forming recess 2212 in the patterning member 221 when being injected into the mold 2.

In summary, the method of making the biochip of the present disclosure may be advantageous over the prior art for achieving miniaturization purposes without causing deformation or damage to the polymer film as encountered in the prior art.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method of making a biochip, comprising:
providing a mold including first and second mold halves, the first mold half being formed with an accommodating groove, the second mold half being provided with a patterning member facing toward the accommodating groove;
securing a substrate in the accommodating groove;
disposing a polymer material on the substrate;
patterning the polymer material through the patterning member in the mold; and
curing the polymer material so as to form a patterned polymer layer on the substrate;
wherein the patterned polymer layer is formed with at least one recess having a pattern that corresponds to that of the patterning member and that is adapted to receive a biological analyte.

2. The method of claim 1, wherein the patterning member includes a plurality of protruding blocks that protrude from an inner surface of the second mold half and that cooperatively define the pattern of the at least one recess in the patterned polymer layer.

3. The method of claim 1, further comprising removing an assembly of the patterned polymer layer and the substrate from the accommodating groove, and covering the patterned polymer layer of the assembly with a sealing layer to seal the recess.

4. The method of claim 1, wherein the polymer material is cured under a temperature that does not result in deformation of the substrate.

5. The method of claim 1, further comprising applying an external force to the first and second mold halves, so that the polymer material is pressed by the mold against the substrate during patterning of the polymer material.

6. The method of claim 1, wherein the first and second mold halves are assembled together after the disposing of the polymer material on the substrate.

7. The method of claim 1, wherein the first and second mold halves are assembled together before the disposing of the polymer material on the substrate, and wherein the disposing of the polymer material on the substrate is conducted through injection molding techniques.

8. The method of claim 7, further comprising heating the second mold half to a predetermined temperature ranging from 100° C. to 150° C.

9. The method of claim 1, wherein the polymer material is made from polysiloxane or silicone resins.

10. The method of claim 1, wherein the first mold half is further formed with a suction channel that is in fluid communication with the accommodating groove, the method further comprising suctioning the suction channel, so that the substrate is brought into abutment against the first mold half by the suction action.

11. The method of claim 10, further comprising disassembling the first and second mold halves and removing an assembly of the substrate and the patterned polymer layer from the accommodating groove.

12. The method of claim 11, wherein the removal of the assembly of the substrate and the patterned polymer layer from the accommodating groove is conducted by injecting a gas into the suction channel.

13. The method of claim 12, wherein the first mold half is further formed with a pin slot that is in spatial communication with the accommodating groove, and is provided with an ejecting pin that extends into the pin slot, the removal of the assembly of the substrate and the patterned polymer layer from the accommodating groove being further conducted by pushing the ejecting pin into the accommodating groove so as to eject the assembly of the substrate and the patterned polymer layer from the accommodating groove.

14. The method of claim 1, wherein the polymer material is thermally curable.

15. The method of claim 1, wherein the polymer material is light curable.

16. The method of claim 15, wherein the substrate and the first mold half are transparent.

17. The method of claim 15, wherein the second mold half is transparent.

18. A biochip comprising:
a substrate; and
a patterned polymer layer molded over said substrate and formed with at least one recess that is adapted to receive a biological analyte;
wherein said patterned polymer layer is bonded to said substrate through molding techniques and has structural characteristics indicative of said patterned polymer layer being formed by molding techniques.

19. The biochip of claim 18, wherein the patterned polymer layer is made from polysiloxane or silicone resins.

20. The biochip of claim 18, wherein the patterned polymer layer is light curable.
